(19) United States
(12) Patent Application Publication
(10) Pub. No.: US 2015/0014238 A1
(43) Pub. Date: Jan. 15, 2015

(54) DEVICE FOR FILTERING A THERMOPLASTIC MELT

(71) Applicant: MAAG PUMP SYSTEMS GMBH, Grossostheim (DE)

(72) Inventor: Harald Pohl, Horstel (DE)

(21) Appl. No.: 14/502,553

(22) Filed: Sep. 30, 2014

Related U.S. Application Data
(63) Continuation of application No. PCT/EP2013/000886, filed on Mar. 22, 2013.

(30) Foreign Application Priority Data
Mar. 30, 2012 (DE) 102012006563.9
Mar. 22, 2013 (EP) PCT/EP2013/000886

(51) Int. Cl. B01D 29/13; B01D 29/52; B01D 29/66

(52) U.S. Cl. CPC B01D 29/13; B01D 29/66; B01D 29/52
USPC 210/333.01

(57) ABSTRACT

A device for filtering a thermoplastic melt, comprising a housing having at least one fluid feed channel and at least one fluid discharge channel and having at least two bores. The bores are in fluid communication with the fluid feed channel and the fluid discharge channel, and each houses a displaceable bolt provided with a filter unit having an inflow side and an outflow side. Each displaceable bolt can be moved at least between a filtering position and a back-flushing position. In a filling position, in which fluid flows from the outflow side of the filter unit to a storage cavity formed in the bore by the movement of the displaceable bolt. When the displaceable bolt moves into the back-flushing position, the fluid then again flows through the filter unit to the at least one back-flushing channel and thus escapes from the housing.

### CROSS REFERENCE TO RELATED APPLICATIONS

The present patent application is a Continuation Application that claims priority to and the benefit of co-pending International Patent Application No. PCT/EP2013/000886, filed Mar. 22, 2013, entitled “DEVICE FOR FILTERING A THERMOPLASTIC MELT”, which claims priority to DE Application No. 102012006563.9 filed Mar. 30, 2012, entitled “DEVICE FOR FILTERING A THERMOPLASTIC MELT”. These references are incorporated in their entirety herein.

### FIELD

The present embodiments generally relate to a device for filtering a fluid.

### BACKGROUND

Devices for filtering a fluid are commonly referred to in the art as screen changers. Screen changers are used, for example, to filter foreign particles from a fluid, such as from molten plastic in the form of its polymer melt.

Large quantities of contaminants may arise, for example, in recycled material. In the course of filtering, it is obvious that the filter or filter unit will sooner or later become clogged with residues, and must be cleaned.

It is desirable for an efficient and versatile device to filter fluids that can be easily taken off line for cleaning and placed back in service.

There is a further need for a device that can quickly be cleaned and placed in service with minimal down time.

The present embodiments meet these needs.

### BRIEF DESCRIPTION OF THE DRAWINGS

The detailed description will be better understood in conjunction with the accompanying drawings as follows:

FIG. 1 shows a perspective plan view of a filter device of an embodiment of the invention.

FIG. 2 shows a schematic, partially cut-away view of a detail of the device of the invention presented in FIG. 1.

FIG. 3 shows a perspective plan view of a filter device of another embodiment of the invention.

FIG. 4 shows a schematic, partially cut-away view of a detail of the device of the invention presented in FIG. 3.

FIG. 5 shows a schematic, cut-away view of a detail of a device of another embodiment of the present invention.

FIG. 6 shows a cross-sectional view of the embodiment of the invention presented in FIG. 5.

FIGS. 7A-7N show schematic, partially cut-away views of the device of the invention as viewed from the outlet side of a melt and as viewed from the inlet side of a melt in various operating states.

FIGS. 8A and 8B show an embodiment of the present invention in a schematic, partially cut-away view as viewed from the outlet side and inlet side, respectively.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The invention relates to a device for filtering a fluid, more particularly for filtering a thermoplastic polymer melt. The device comprises a housing having at least one fluid feed channel and at least one fluid discharge channel and having at least two mutually parallel and interspaced bores in respective fluid communication with the fluid feed channel and the fluid discharge channel.

Each of the bores houses in a fluid-tight manner, an axially displaceable and/or radially rotatable bolt. Each displaceable bolt comprises a filter unit having an inflow side and an outflow side, wherein each of said bolts can be moved at least between a first, filtering position, in which the inflow and outflow sides of the filter unit are in respective fluid communication with the fluid feed channel and the fluid discharge channel, and a second, back-flushing position, in which the inflow side of the filter unit is in fluid communication with at least one back-flushing channel in the housing.

Devices for filtering a fluid are commonly referred to in the art as screen changers. Screen changers are used, for example, to filter foreign particles from a fluid, such as from molten plastic in the form of its polymer melt. Large quantities of such contaminants may arise, for example, in recycled material. In the course of filtering, it is obvious that the filter or filter unit will sooner or later become clogged with residues, and must be cleaned.

It is preferably the case that two filter systems are configured in parallel, thus making it possible for one filter system to remain in operation while the other undergoes cleaning. One method of cleaning a filter is by back-flushing with a previously filtered fluid in a direction opposite the filtering flow direction of the fluid. Devices incorporating this methodology are referred to in the art as back-flush screen changers.

Such filter devices are often used in applications that are highly critical with respect to the mass flow of the fluid, such as in the production of thin plastic films. It is desirable to be able to guarantee the continuous flow of filtered fluid without variations of particulate concentrations, even when a filter needs cleaning or replacing.

The Applicant's German utility model DE 20 2010 017 247 U1 provides such a device for filtering a fluid in which various bolts are ingeniously arranged in a multi-part housing. Some bolts serve to hold the screens, while other bolts are movable to create separate cavities that can be filled with previously filtered fluid. With the movable bolts and screen-holding bolts in the back-flushing position, said fluid is then used to clean the screen surfaces by back-flushing. The therein-employed division between functionally separate bolt arrangements serves to maintain a constant melt flow, including when a filter is replaced or during back-flushing to clean an individual filter.

The Applicant's German Patent DE 196 12 790 C2 describes a device for filtering a fluid in which two filters are arranged in a common bolt, with the result that, depending on the position of the axially displaceable and radially rotatable bolt, the flow can be directed through different cavities in the axially displaceable and radially rotatable bolt in different side-streams.

European patent specification EP 1 778 379 B1 describes a device and method for filtering a fluid, more especially for plastics-processing machines, said device and/or method likewise being intended to maintain a constant flow rate also during back-flushing. Said device employs an additional movable bolt in a melt channel downstream of a filter unit. With the filter unit suitably positioned, said movable bolt is able to press previously filtered melt through the filter in a direction opposite to the production direction in a back-flushing operation. Once again in said device, the multi-part configuration in combination with a functional separation into different bolts, a filter-carrying bolt and a movable bolt, makes it possible to maintain a generally continuous flow of melt, including during cleaning.

European patent specification EP 0 577 680 B1 describes a filtering device for fluids to be cleaned in which disposed within a piston carrying the filter is another piston that, whenever back-flushing is required, is capable of pressing previously filtered material through the filter in a counter-flow. Once again, the functions of filter-carrying piston and additional movable piston are separately configured and implemented.

The publication WO 98/47688 describes a filter for viscous masses in which, once again, previously filtered fluid can be pressed by an additional movable piston in a melt channel through the suitably positioned filter in a back-flushing operation to suitably clean the filter. Said device, too, provides a functional separation between screen carrier and movable piston.

The object of the present invention, therefore, is to provide a device for filtering a fluid, and more particularly for filtering a thermoplastic polymer melt material, in which filter cleaning by back-flushing is made possible by simple design means. A particular object of the invention is to allow back-flushing of the fluid without disruptions or mass losses in the main stream during back-flushing. A further object of the invention is to prevent material from collecting in the region of the device and thus from solidifying and causing disruptions during back-flushing.

The device for filtering a fluid, such as a thermoplastic polymer melt, comprises a housing having at least one fluid feed channel and at least one fluid discharge channel and having at least two mutually parallel and interspaced bores in respective fluid communication with the fluid feed channel and the fluid discharge channel, wherein each of the bores houses in fluid-tight manner a therein axially displaceable and radially rotatable bolt, each of said bolts being provided with a filter unit having an inflow side and an outflow side.

Each of the bolts can be moved at least between a first, filtering position, in which the inflow and outflow sides of the filter unit are in respective fluid communication with the fluid feed channel and the fluid discharge channel, and a second, back-flushing position, in which the inflow side of the filter unit is in fluid communication with at least one back-flushing channel in the housing.

According to the invention, each of the axially displaceable and radially rotatable bolts can be moved into a third, filling position, in which fluid flows, through a clean-fluid channel in the axially displaceable and radially rotatable bolt, from the outflow side of the filter unit to a storage cavity formed in the bore by the movement of the axially displaceable and radially rotatable bolt, wherein, when the axially displaceable and radially rotatable bolt moves into the second position, said fluid then again flows through the filter unit to the at least one back-flushing channel and thus escapes from the housing.

In the course of the entire corresponding inventive movement of the axially displaceable and radially rotatable bolt during filling (third position) and during back-flushing (second position), therefore, the creation/enlargement and filling with fluid of the storage cavity (collectively referred to as the third position) and the reduction in size or, ultimately, disappearance and back-pressing of the fluid of the storage cavity (collectively referred to as the second position) takes place while the axially displaceable and radially rotatable bolt is correspondingly moved axially backwards and forwards, similarly to a syringe.

Therefore, the invention makes it possible for the function of creating a cavity to receive previously filtered fluid from production to be combined in one component with the correspondingly possible back-flushing by movement of the axially displaceable and radially rotatable bolt, this allowing the previously collected fluid to be back-flushed through the corresponding filter in the same bolt.

In addition, the appropriate provision of two parallel bolt arrangements guarantees the continuous melt flow of filtered fluid during the production process of a complete system. In contrast to the prior art, therefore, it is not necessary according to the invention to provide a separate displacement piston, which would additionally necessitate separate movement mechanisms.

In a single arrangement with just one bolt and just one suitably assigned actuator, the axially displaceable and radially rotatable bolt, which also houses the screening surface, can simply not only provide the corresponding volume for holding filtered fluid, but can also displace said fluid in the back-flushing position during back-flushing through the screening surface. This results in an especially simple design that can also be integrated in compact and space-saving manner into larger complete production systems.

According to the described and claimed device of the invention, therefore, the “positions” are to be understood in the sense of variable positions with respect to the position of the axially displaceable and radially rotatable bolt, said positions additionally including a movement of the axially displaceable and radially rotatable bolt and not being limited to static “end points” of corresponding movements. This applies in particular to the second and third positions, which include a corresponding movement of the axially displaceable and radially rotatable bolt according to the invention to create/fill and to compress/expel the fluid in/from the storage cavity during the filling and back-flushing operations, respectively.

According to a preferred embodiment of invention, with the axially displaceable and radially rotatable bolt in the first position, the outflow side of the filter unit is in communication with the at least one fluid discharge channel through the intermediary of the clean-fluid channel and through the intermediary of a radial groove disposed on the end face of the axially displaceable and radially rotatable bolt and extending only over some of the circumference of one end face of the axially displaceable and radially rotatable bolt and through the intermediary of an axially extending longitudinal groove of the axially displaceable and radially rotatable bolt.

The preferred provision of radial and longitudinal grooves according to the invention makes it especially reliably possible in every case to guarantee a constant flow of fluid, including when the axially displaceable and radially rotatable bolt is in the first position. Consequently, there is no clogging with melt, which might otherwise collect and solidify in dead spaces.

According to a preferred embodiment of the invention, the longitudinal groove extends only over some of the axial length of the axially displaceable and radially rotatable bolt.

In a preferred embodiment of the invention, the radial groove on one end face of the axially displaceable and radially rotatable bolt is covered there by a cover plate, said cover plate being provided with a therethrough extending through-opening to create a fluid communication between the radial groove and the storage cavity during the movement of the axially displaceable and radially rotatable bolt, especially during the axial displacement of the axially displaceable and radially rotatable bolt in a forward or backward direction.

Also the cover plate preferably provided according to the invention ensures that the fluid does not collect there during filling and is able to continue to be back-flushed in the back-flushing position without a tendency to solidify.

In another preferred embodiment of the invention, the axial movement of the axially displaceable and radially rotatable bolt from the first position into the third position results at the end face of said bolt in the formation of the storage cavity for filtered fluid, wherein, over the entire distance of said axial movement, the outflow side of the filter unit is in communication with the at least one fluid discharge channel through the intermediary of the clean-fluid channel, the radial groove and the longitudinal groove.

This preferred design according to the invention guarantees in especially reliable manner a constant flow of fluid, with the result that the solidification of fluid in any otherwise occurring cavities or dead spaces is not to be feared.

In a further preferred embodiment of the invention, the axially displaceable and radially rotatable bolt is movable from the first position by radial rotation into a first intermediate position, wherein, depending on the magnitude of the rotation angle, the fluid discharge channel is partially or completely sealed by the wall of the axially displaceable and radially rotatable bolt, such that, in case of complete sealing, the axially extending longitudinal groove of the axially displaceable and radially rotatable bolt is no longer in communication with the at least one fluid discharge channel.

A further preferred embodiment of the invention provides that, with the axially displaceable and radially rotatable bolt in a second intermediate position and depending on the magnitude of the rotation angle, the fluid feed channel is partially or completely sealed by the wall of the axially displaceable and radially rotatable bolt, such that, in case of complete sealing, the inflow side of the filter unit of the axially displaceable and radially rotatable bolt is no longer in communication with the at least one fluid feed channel.

The appropriate use of the lateral surface of the axially displaceable and radially rotatable bolt to seal corresponding openings in the housing allows an especially simple design for melt flow control in the filter. More particularly, this makes it possible for the dimensions of the axially displaceable and radially rotatable bolt to be kept very compact without additional need for complex valves or sealing arrangements.

In an advantageous embodiment of the invention, the axially displaceable and radially rotatable bolt is preferably so movable that it is simultaneously both in the second position and in the first intermediate position.

In a further advantageous embodiment of the invention, the axially displaceable and radially rotatable bolt is preferably so movable that it is simultaneously both in the third position and in the second intermediate position.

In yet a further advantageous embodiment of the invention, the axially displaceable and radially rotatable bolt is preferably so movable that it is simultaneously both in the first and second intermediate positions and/or in the second and third positions.

Sealing by the axially displaceable and radially rotatable bolt itself can thus be provided in especially effective manner and with simplicity of design by means of contact of the lateral surface of the axially displaceable and radially rotatable bolt to seal the corresponding openings of the housing.

In a further preferred embodiment of the invention, each filter unit is associated with at least one back-flushing channel.

The provision of a plurality of bores and back-flushing channels makes it possible for the continuous flow of melt to be realized in especially simple manner also during back-flushing of the screens in one of the axially displaceable and radially rotatable bolts.

In a preferred embodiment of the invention, the axially displaceable and radially rotatable bolt is provided with an outlet channel, wherein, with the axially displaceable and radially rotatable bolt in a fourth, starting position, said outlet channel can be brought into fluid communication with the fluid feed channel and has an opening to the surrounding area of the device, such that fluid can be discharged from the device through said opening.

The housing of the invention preferably consists of one or more parts, preferably of two parts, each housing part having a bore, a fluid feed channel and a fluid discharge channel as well as a bolt with a filter unit, a back-flushing channel and an outlet channel.

In a further preferred embodiment of the invention, the axially displaceable and radially rotatable bolt can be moved into a fifth, screen-changing position, in which the filter unit is outside of the housing to allow replacement of the filter unit in said position, said fifth position being in the opposite direction to the end face of the axially displaceable and radially rotatable bolt.

Consequently, in the fifth position, if a change of screen is required, this can easily be accomplished without the need for the entire device to be completely disassembled. More particularly, it is not necessary, when a screen is being changed, for the sealing end face region of the axially displaceable and radially rotatable bolt to be completely removed from the bore of the housing. Under certain physical conditions, however, an end-face screen change may also be advantageous if the available space at the opposite end of the filter device is insufficient to change the filter at that end. In such a case, the fifth position can alternatively be realized with a bolt adapted to be pulled out from the end face after removal of a cover plate there.

In an especially preferred embodiment, the axially displaceable and radially rotatable bolt is so long and movable that, in the fifth position, the at least one fluid feed channel and the at least one fluid discharge channel are completely sealed by the wall of the axially displaceable and radially rotatable bolt.

In a preferred embodiment of the invention, shut-off valves are provided upstream of the at least one fluid feed channel and downstream of the at least one fluid discharge channel, wherein, with the axially displaceable and radially rotatable bolt in the fifth position, said shut-off valves allow the respective channels to be sealed.

In an advantageous, extremely simple preferred embodiment of the invention, the design of the axially displaceable and radially rotatable bolts is such that the starting position of the axially displaceable and radially rotatable bolt, i.e. the above-described fourth position, is identical to the above-described fifth, screen-changing position.

To make the axially displaceable and radially rotatable bolt as compact of construction as possible, so that, in case of a change of screen, there are no sealing bolt surfaces that can cover the corresponding openings in the housing, the embodiment with the aforementioned shut-off valves nonetheless allows the melt flow to be shut off in relatively simple manner. This makes it possible for the axially displaceable and radially rotatable bolt to be of a shorter axial length, which can be advantageous under certain physical conditions of a complete system.

In a preferred embodiment of the invention, the device comprises two bolts, said bolts being movable independently of each other between the first position, the second position, the third position, the fourth position, the fifth position and the first and second intermediate positions and being held in the housing by corresponding bores, wherein, with the axially displaceable and radially rotatable bolt in the first position, the fluid to be filtered is filtered and, with the axially displaceable and radially rotatable bolt in the second position, fluid to be filtered does not flow through the filter unit of said bolt, said filter unit instead being subjected to a flow, opposite to the filtering direction, of filtered fluid supplied from the storage cavity associated with said bolt, wherein, during filtering by the other bolt, the storage cavity associated with the one bolt is filled with filtered fluid through axial movement of the one bolt from the first position into the third position or into the third and simultaneously intermediate position, wherein at least some of the thus stored fluid is then supplied to the filter unit of the one bolt through the movement of the one bolt when the one bolt is moved from the third position or the third position and simultaneously second intermediate position into the second position or the second position and simultaneously first intermediate position.

Consequently, operation of the complete machine can be continuously accomplished in alternation by suitably intermittent movements of the respective bolts according to the invention.

In the described manner with a simplicity of design, therefore, the invention allows a continuous productive operation without major variations in the production flow of the filtered melt, it being simultaneously possible for individual filter elements to be suitably cleaned by back-flushing.

Hereinbelow, a non-limiting example embodiment of the invention will be more fully explained and described reference to the drawings, in which:

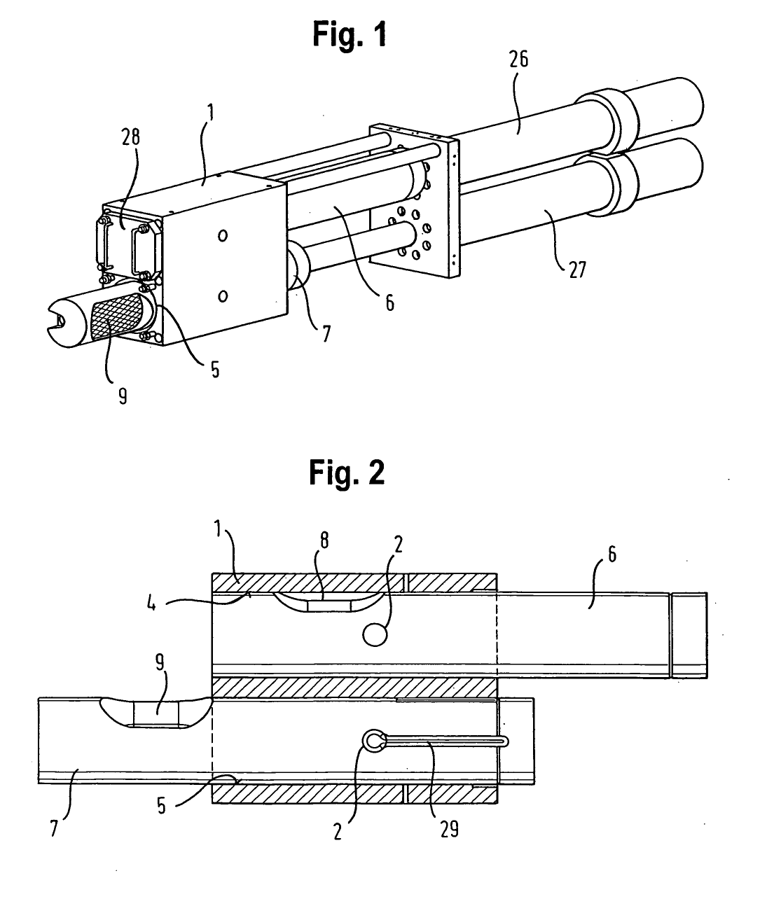

FIG. 1 shows a perspective plan view of a filter device of a first preferred embodiment of the invention;

FIG. 2 shows a schematic, partially cut-away view of a detail of the device of the preferred embodiment of the invention presented in FIG. 1.

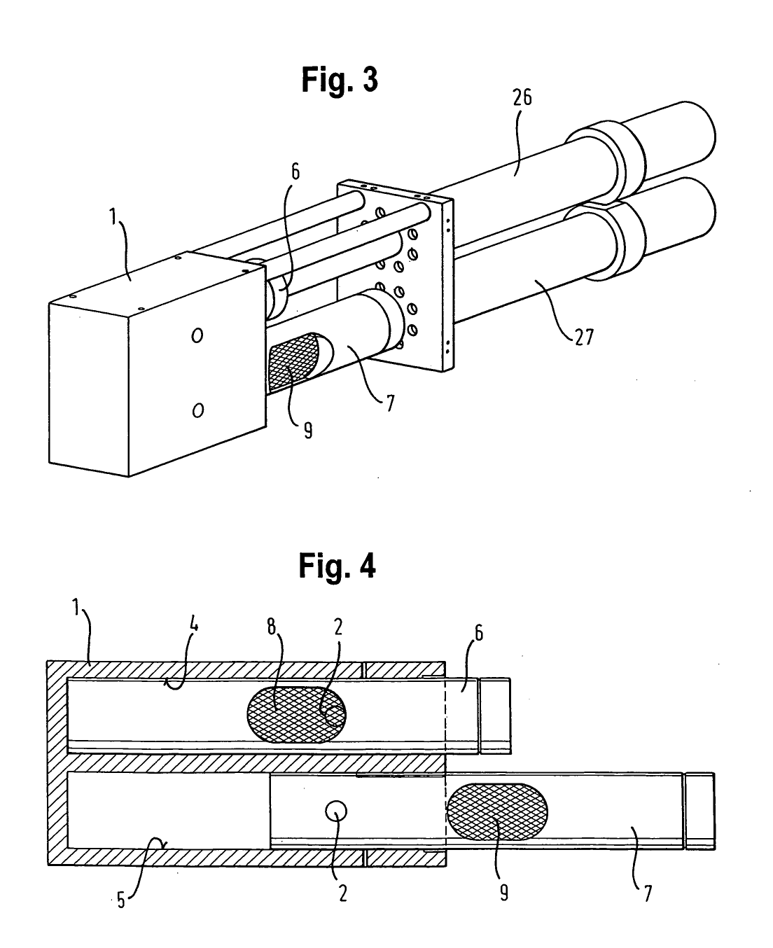

FIG. 3 shows a perspective plan view of a filter device of a second preferred embodiment of the invention.

FIG. 4 shows a schematic, partially cut-away view of a detail of the device of the preferred embodiment of the invention presented in FIG. 3.

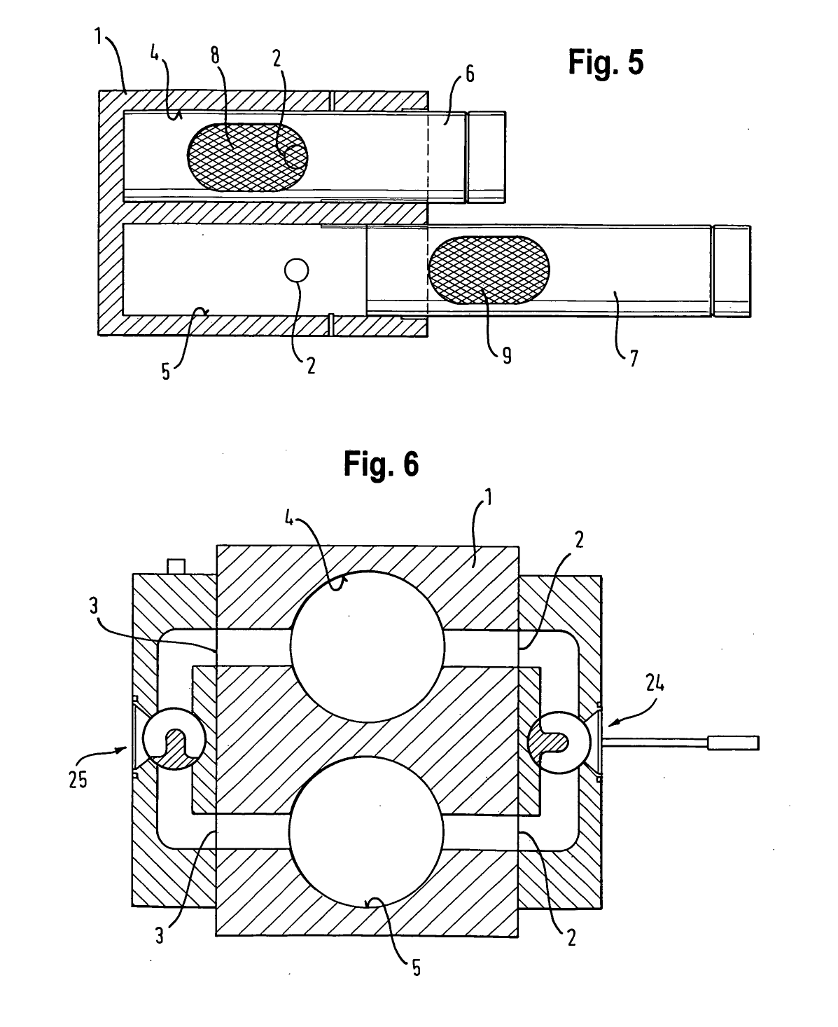

FIG. 5 shows a schematic, cut-away view of a detail of a device of a further preferred embodiment of the present invention.

FIG. 6 shows a cross-sectional view of the preferred embodiment of the invention presented in FIG. 5;

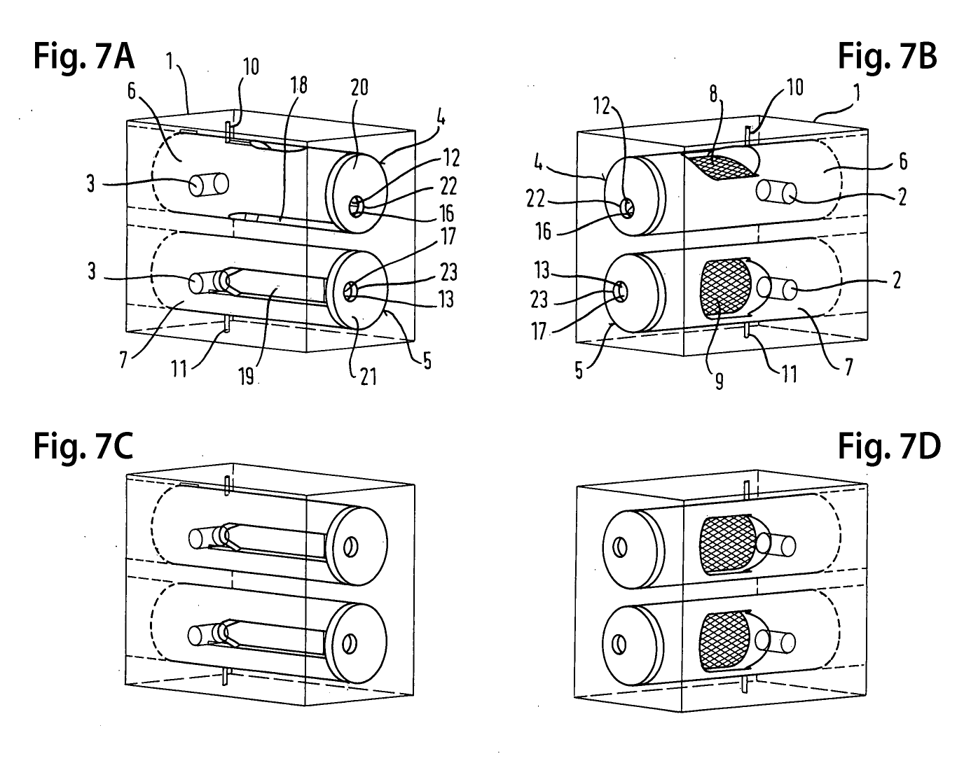

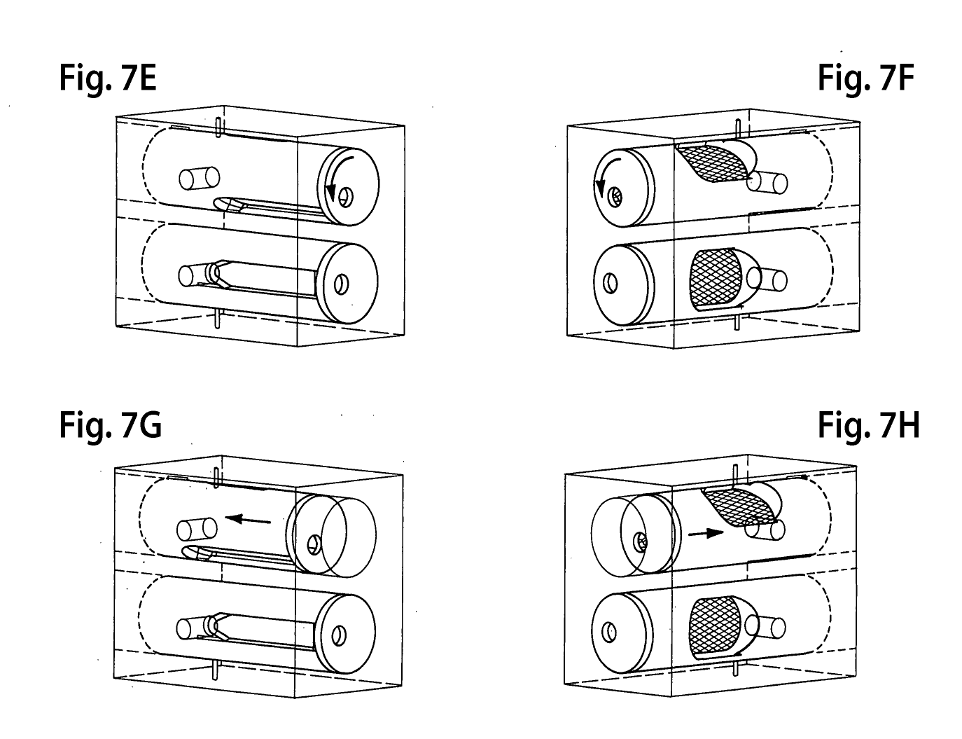

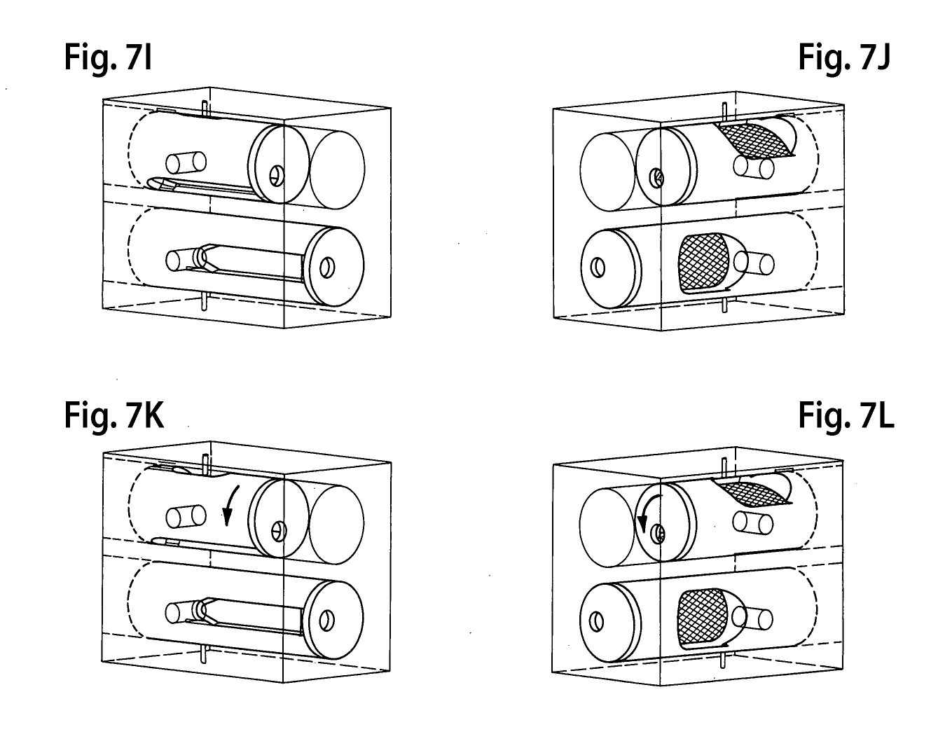

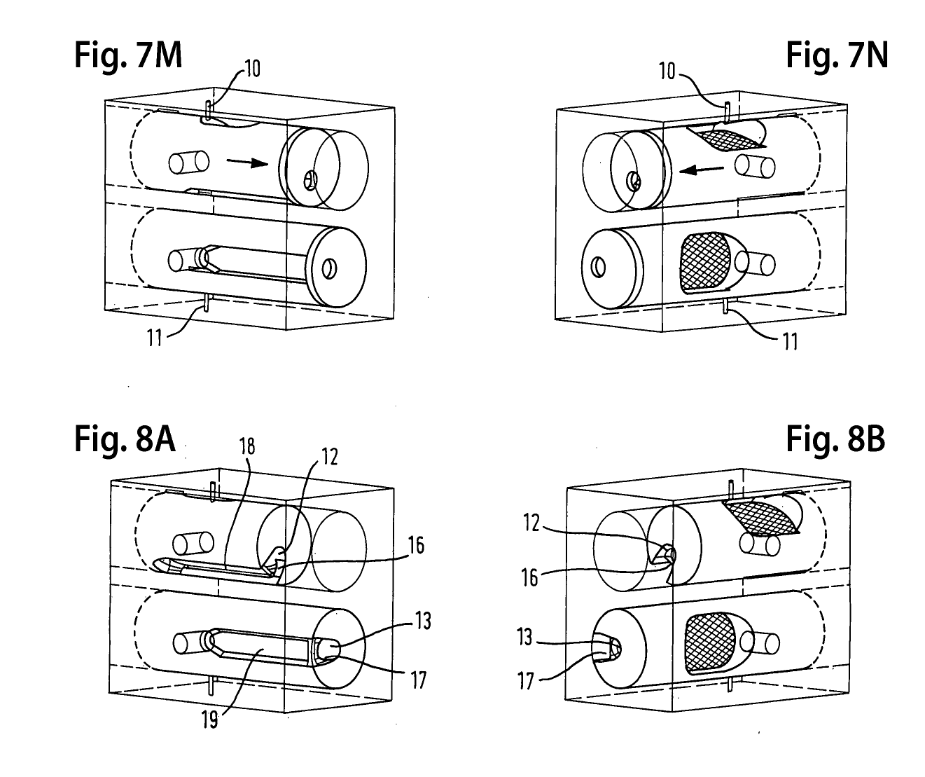

FIGS. 7A-7N show schematic, partially cut-away views of the device of the invention as viewed from the outlet side of a melt and as viewed from the inlet side of a melt in various operating states.

FIGS. 8A and 8B show a further preferred embodiment of the present invention in a schematic, partially cut-away view as viewed from the outlet side and inlet side, respectively.

In the drawings, identical components are identified by identical reference characters, the reference characters being omitted in some drawings in the interests of clarity. The individual described components according to the preferred embodiments of the present invention can be combined at will in a manner familiar to the person skilled in the art. The presented embodiments are non-limiting with regard to the respective combinations.

FIG. 1 shows a perspective plan view of a device for filtering a fluid according to a first preferred embodiment of the present invention. The presented device serves in particular to filter a thermoplastic polymer melt and comprises a housing 1 with bolts 6, 7, said bolts 6, 7 being movable, i.e. axially displaceable and/or radially rotatable in fluid-tight manner, in the housing 1 in bores 4, 5 (upper bore 4 not visible in FIG. 1). Each of the axially displaceable and radially rotatable bolts 6, 7 comprises at least one filter unit 8, 9 (upper filter unit 8 not visible in FIG. 1), with an inflow side and an outflow side. FIG. 1 shows the lower bolt 7 in a fifth, screen-changing position. According to the embodiment of the inventive device presented in FIG. 1, after removal of a cover plate, which is still shown for the upper bolt and is mounted on the housing (mounted cover plate 28), the axially displaceable and radially rotatable bolt is pushed out of the housing by the respective actuator 26, 27 at the opposite end of the housing 1 to allow the screen to be changed from the axially displaceable and radially rotatable bolt end.

FIG. 2 shows a schematic sectional view of a detail of the inventive device presented in FIG. 1, namely a lower bolt 7 in a fifth, screen-changing position, in which it has been pushed out from the end face of the housing in a direction away from the actuator end. In FIG. 2, the therein shown upper bolt 6 is in a second, back-flushing position. FIG. 2 further shows an outlet channel 29 at least of the lower bolt 7, through which outlet channel 29 said bolt 7 can, in the position shown, be brought into fluid communication with the fluid feed channel 2 and has an opening to the surrounding area of the device to allow, for example, non-compliant fluid, e.g. during starting, to be discharged from the device. The corresponding outlet channel of the upper bolt 6 is not visible in FIG. 2 owing to the rotated position of the axially displaceable and radially rotatable bolt 6.

FIG. 3 shows a perspective plan view of a device for filtering a fluid according to a second preferred embodiment of the invention. According to the embodiment of the inventive device presented in FIG. 3, in contrast to the embodiment of the invention presented in FIG. 1, the axially displaceable and radially rotatable bolt 6, 7 is adapted to be pushed out of the housing 1 into the screen-changing position in a direction towards the respective actuator 26, 27. According to FIG. 3, therefore, the therein presented invention is so configured that, in this case, the fifth, filter-changing position is not at the end face, but is accomplished by the axially displaceable and radially rotatable bolt 7 being pushed out of the housing in the direction of the actuator 27.

The actuators 26, 27 shown in FIGS. 1 and 3 for moving the respective bolts 6, 7 are preferably hydraulic cylinders, said hydraulic cylinders being connected by appropriate linkages to the axially displaceable and radially rotatable bolts according to the invention and allowing the described bolt movements in the axial and radial directions with corresponding sliding and rotational movements. This is not explained in further detail, because the basic use of such hydraulic cylinders will be familiar to the person skilled in the art.

FIG. 4 shows a schematic sectional view of a detail of the inventive device presented in FIG. 3, namely a lower bolt 7 in a filter-changing position, in which it has been pushed out of the housing towards the actuator side. The axially displaceable and radially rotatable bolt 6, like the axially displaceable and radially rotatable bolt 7, is of a length in the axial direction that makes it possible for the respective bore of the fluid feed channel 2 (and also of the fluid discharge channel 3 (albeit not visible in FIGS. 1 to 5)) to be sealed by the axially displaceable and radially rotatable bolt wall when the corresponding bolt is in the fifth, screen-changing position. In FIG. 4, the therein presented upper bolt 6 is in a first, operating position.

The only difference between FIG. 5 and FIG. 4 is that the therein shown bolts 6 and 7 are shorter, with the consequence that a fluid-tight seal of the fluid feed channel 2 or fluid discharge channel 3 by the axially displaceable and radially rotatable bolt wall is not possible. Therefore, the embodiment presented in FIG. 5 requires the use of additional sealing elements.

Such sealing elements are shown in a schematic sectional view in FIG. 6. FIG. 6 shows a cross-sectional view of a housing 1 with the therein disposed bores 4, 5, in which the axially displaceable and radially rotatable bolts 6, 7 are axially movable and radially rotatable in fluid-tight manner. However, the axially displaceable and radially rotatable bolts are not shown in FIG. 5. To allow the fluid stream to be interrupted in the case of a filter change, i.e. when one or both bolts are in the fifth position, shut-off valves 24, 25 in the form of rotary slide valves are provided upstream of the fluid feed channel 2 and the fluid discharge channel 3. With the axially displaceable and radially rotatable bolt in the fifth position, said shut-off valves 24, 25 allow the respective channel 2, 3 to be closed off.

FIGS. 7A-7N show schematic views of the position of one of the axially displaceable and radially rotatable bolts 6, 7 in the housing 1 according to a preferred embodiment of the invention as viewed from a fluid outlet side and as viewed from a fluid inlet side.

FIGS. 7A-7N show the device for filtering a fluid according to the invention, said device being suitable especially for filtering a thermoplastic polymer melt. In the housing with interspaced bores 4, 5, a fluid feed channel 2 and a fluid discharge channel 3 are associated with the respective mutually parallel bores and are in fluid communication with said bores. According to the presented embodiment, the housing 1 is of one-part construction. In principle, however, it is also possible for each of the housing parts to be provided with a separate bore and to be correspondingly realized in a multi-part housing.

Each of the bores 4, 5 houses a bolt 6, 7, which is axially movable and radially rotatable therein in fluid-tight manner. Movement of the axially displaceable and radially rotatable bolts can be accomplished by the actuators 26, 27 (see e.g. FIG. 1 or FIG. 3). Each of the axially displaceable and radially rotatable bolts 6, 7 has a filter unit 8, 9 with an inlet side, to allow the inflow of fluid to be filtered, and with an outlet side, to allow the filtered fluid to flow out after the filter unit. As shown in FIGS. 7A and 7E the lower bolt 7 is in a first, filtering position, in which the filter unit 9 is in fluid communication with the inlet side with the fluid channel 2 and with the outlet side with the fluid channel 3. As shown in FIGS. 7A and 7E, the upper bolt 6 is in an end position of a second, back-flushing position, in which the filter unit 8 of the upper bolt 6 is in fluid communication with the inlet side thereof with an associated back-flushing channel 10. In the drawing, the back-flushing operation has already been completed.

FIGS. 7E, 7G shows both bolts 6, 7 in the first, filtering position, in which the outflow side of the filter unit 8, 9 of the axially displaceable and radially rotatable bolt is in communication with the fluid discharge channel 3 through the intermediary of the clean-fluid channel 12, 13 and through the intermediary of a radial groove 16, 17 disposed on the end face of the axially displaceable and radially rotatable bolt 6, 7 and extending only over some of the circumference of one end face of the axially displaceable and radially rotatable bolt and through the intermediary of an axially extending longitudinal groove 18, 19 of the axially displaceable and radially rotatable bolt 6, 7. According to the embodiment of the inventive device shown in the figures of the sequence in FIGS. 7A-7N, the radial groove 16, 17 on the end face of the axially displaceable and radially rotatable bolt 6, 7 is covered there by a cover plate 20, 21, said cover plate 20, 21 being provided with a therethrough extending through-opening 22, 23. In a subsequently shown third position of the axially displaceable and radially rotatable bolt 6, 7, said through-opening can create a fluid communication between the radial groove and a storage cavity 14, 16.

In FIGS. 7E, 7F of the sequence presented, the upper bolt 6 has been displaced by radial rotation from the first position into a first intermediate position, with the result that, depending on the magnitude of the rotation angle, the associated fluid discharge channel 3 is partially or, as shown in FIGS. 7E, 7F, completely sealed by the wall of the axially displaceable and radially rotatable bolt 6. Consequently, in the case of such complete sealing, the axially extending longitudinal groove 18 of the axially displaceable and radially rotatable bolt 6 is no longer in fluid communication with the fluid discharge channel 3 of said bolt.

As shown in FIGS. 7G, 7H, the axially displaceable and radially rotatable bolt 6 is in an axial displacement movement in a third, filling position, in which the fluid flows via the clean-fluid channel 12 of the axially displaceable and radially rotatable bolt 6 from the outflow side of the filter unit 8 to a storage cavity 14 formed by the movement of the axially displaceable and radially rotatable bolt 6 in the bore 3 (the corresponding storage cavity 15 of the lower bolt 6 is not shown in the drawings). The movement of the axially displaceable and radially rotatable bolt 6 is represented by the arrow in the drawing.

The states of movement of the axially displaceable and radially rotatable bolts 6, 7 are in all cases visualized by corresponding arrows in the drawings.

With the upper bolt 6 in the position shown in FIGS. 7I, 7J, the filling operation, which has taken place according to the movement in the third position of said bolt 6, is completed, and the thus formed storage cavity 14 has been filled with fluid from the outflow side of the filter unit 8. As shown in FIGS. 7I, 7J, the axially displaceable and radially rotatable bolt 6 has been rotated into a second intermediate position, in which, depending on the magnitude of the rotation angle, the axially displaceable and radially rotatable bolt 6 partially or, as shown in FIGS. 7I, 7J, completely seals the fluid feed channel 2 with its wall, with the result that the inflow side of the filter unit 8 of the axially displaceable and radially rotatable bolt 6 is no longer in communication with the associated fluid feed channel 2.

Back-flushing of the filter unit 8 of the axially displaceable and radially rotatable bolt 6 can now take place. With reference to FIGS. 7K, 7L, it can be seen that, through renewed back-movement of the axially displaceable and radially rotatable bolt 6 in the bore 4, the fluid is pressed out of the storage cavity 14 back to the outflow side of the filter unit 8 and through the filter unit 8 to its inflow side, flowing to the back-flushing channel 10 associated with said bolt 6 and thus being able to escape from the housing 1. The axially displaceable and radially rotatable bolt 6 is in a second, back-flushing position, in which the filter unit 8 is in fluid communication with the inflow side with at least the back-flushing channel 10 and in which the axially displaceable and radially rotatable bolt 6 is correspondingly further moved in the axial direction.

FIGS. 7M, 7N shows the end of the movement of the axially displaceable and radially rotatable bolt 6 in the second position, it being indicated by the representation in FIGS. 7M, 7N that the fluid communication between the inflow side of the filter unit 8 and the associated back-flushing channel 10 is in fluid communication already when the corresponding bolt moves back in the direction of the first position.

Similarly to the sequence presented in FIGS. 7A, 7E to 7M, 7N, the representation in FIGS. 8A, 8B shows the schematic sequence of an embodiment of the invention. The embodiment shown in FIGS. 8A, 8B differs from the embodiment in the sequential representation in FIGS. 7A-7N in that, in FIGS. 8A, 8B, there is no cover plate 20, 21 covering the radial groove 16, 17 at the end face of the axially displaceable and radially rotatable bolt 6, 7.

With the invention, it is possible, using just the axially displaceable and radially rotatable bolt, which carries the filter unit, i.e. simply through corresponding movement of said bolt, to obtain back-flushing fluid, which can then be back-flushed through the filter unit of the axially displaceable and radially rotatable bolt by movement of the axially displaceable and radially rotatable bolt itself. Consequently, elaborate prior-art solutions employing several additional bolts and additional fluid connections are not necessary according to the invention.

The invention is capable, therefore, of allowing a simple and compact design for reliable back-flushing and, therefore, cleaning of the corresponding filter device. Consequently, the invention provides a filter device of simple design without high constructional complexity that is reliable in use, easy to operate and quick to clean by back-flushing.

While these embodiments have been described with emphasis on the embodiments, it should be understood that within the scope of the appended claims, the embodiments might be practiced other than as specifically described herein.

What is claimed is:

1. A device for filtering a fluid comprising a housing, wherein the housing comprises:
a. at least one fluid feed channel and at least one fluid discharge channel;
b. at least two mutually parallel and interspaced bores in respective fluid communication with the fluid feed channel and the fluid discharge channel; and
c. a displaceable bolt in each interspaced bore, wherein the displaceable bolt comprises a filter unit having an inflow side and an outflow side, and further wherein the displaceable bolt can be moved at least between a first, filtering position, in which the inflow and outflow sides of the filter unit are in respective fluid communication with the fluid feed channel and the fluid discharge channel, and a second, back-flushing position, in which the inflow side of the filter unit is in fluid communication with at least one back-flushing channel in the housing, and further wherein the displaceable bolt can be moved to a third, filling position, in which fluid flows, through a clean-fluid channel in the axially displaceable and radially rotatable bolt, from the outflow side of the filter unit to a storage cavity formed in the interspaced bore by the movement of the axially displaceable and radially rotatable bolt, such that when the displaceable bolt moves into the second position, fluid flows through the filter unit to the at least one back-flushing channel.

2. The device of claim 1, wherein when the displaceable bolt is in the first position, the outflow side of the filter unit is in communication with the at least one fluid discharge channel through an intermediary of the clean-fluid channel and through an intermediary of a radial groove disposed on the end face of the displaceable bolt and extending only over some of the circumference of one end face of the displaceable bolt and through an intermediary of an axially extending longitudinal groove disposed upon the axially displaceable and radially rotatable bolt.

3. The device of claim 1, further comprising a cover plate connected to the radial groove, wherein the cover plate comprises a through-opening to create a fluid communication between the radial groove and the storage cavity in the third position.

4. The device of claim 2, further comprising a cover plate connected to the radial groove, wherein the cover plate comprises a through-opening to create a fluid communication between the radial groove and the storage cavity in the third position

5. The device of claim 1, characterized in that at least one of:
a. axial movement of the displaceable bolt from the first position into the third position results in the formation of the storage cavity for filtered fluid proximate the end face, wherein, over the entire distance of said axial movement, the outflow side of the filter unit is in communication with the at least one fluid discharge channel through the intermediary of the clean-fluid channel, the radial groove and the longitudinal groove;
b. the displaceable bolt is movable from the first position by radial rotation into a first intermediate position, wherein the fluid discharge channel is partially or completely sealed by the wall of the axially displaceable and radially rotatable bolt, wherein when completely sealed, the axially extending longitudinal groove of the displaceable bolt is no longer in communication with the at least one fluid discharge channel;
c. the displaceable bolt is moveable to a second intermediate position, wherein the fluid feed channel is partially or completely sealed by the wall of the axially displaceable and radially rotatable bolt, wherein when completely sealed, the inflow side of the filter unit of the displaceable bolt is no longer in communication with the at least one fluid feed channel;
d. the longitudinal groove extends only over some of the axial length of the axially displaceable and radially rotatable bolt;
e. each filter unit is associated with at least one back-flushing channel;
f. the displaceable bolt is provided with an outlet channel, wherein with the bolt in a fourth position, the outlet channel can be brought into fluid communication with the fluid feed channel and has an opening to the surrounding area of the device;
g. the housing comprises a plurality of parts, each of the plurality of parts having the bore, the fluid feed channel, the fluid discharge channel, the axially displaceable and radially rotatable bolt, the filter unit, the at least one back-flushing channel and the outlet channel;
h. the displaceable bolt is movable into a fifth, screen-changing position, wherein the filter unit is outside of the housing to allow replacement of the filter unit;
i. the displaceable bolt is movable into a fifth, screen-changing position, wherein the filter unit is outside of the housing to allow replacement of the filter unit and the at least one fluid feed channel and the at least one fluid discharge channel are completely sealed by the axially displaceable and radially rotatable bolt;
j. at least one shut-off valve is provided upstream of the at least one fluid feed channel and at least one shut-off valve is provided downstream of the at least one fluid discharge channel allowing the respective channels to be sealed with the displaceable bolt is in the fifth, screen-changing position; or
k. the fluid is a thermoplastic melt.

6. The device of claim 2, characterized in that at least one of:
a. axial movement of the displaceable bolt from the first position into the third position results in the formation of the storage cavity for filtered fluid proximate the end face, wherein, over the entire distance of said axial movement, the outflow side of the filter unit is in communication with the at least one fluid discharge channel through the intermediary of the clean-fluid channel, the radial groove and the longitudinal groove;
b. the displaceable bolt is movable from the first position by radial rotation into a first intermediate position, wherein the fluid discharge channel is partially or completely sealed by the wall of the axially displaceable and radially rotatable bolt, wherein when completely sealed, the axially extending longitudinal groove of the displaceable bolt is no longer in communication with the at least one fluid discharge channel;
c. the displaceable bolt is moveable to a second intermediate position, wherein the fluid feed channel is partially or completely sealed by the wall of the axially displaceable and radially rotatable bolt, wherein when completely sealed, the inflow side of the filter unit of the displaceable bolt is no longer in communication with the at least one fluid feed channel;
d. the longitudinal groove extends only over some of the axial length of the axially displaceable and radially rotatable bolt;
e. each filter unit is associated with at least one back-flushing channel;
f. the displaceable bolt is provided with an outlet channel, wherein with the bolt in a fourth position, the outlet channel can be brought into fluid communication with the fluid feed channel and has an opening to the surrounding area of the device;
g. the housing comprises a plurality of parts, each of the plurality of parts having the bore, the fluid feed channel, the fluid discharge channel, the axially displaceable and radially rotatable bolt, the filter unit, the at least one back-flushing channel and the outlet channel;
h. the displaceable bolt is movable into a fifth, screen-changing position, wherein the filter unit is outside of the housing to allow replacement of the filter unit;
i. the displaceable bolt is movable into a fifth, screen-changing position, wherein the filter unit is outside of the housing to allow replacement of the filter unit and the at least one fluid feed channel and the at least one fluid discharge channel are completely sealed by the axially displaceable and radially rotatable bolt;
j. at least one shut-off valve is provided upstream of the at least one fluid feed channel and at least one shut-off valve is provided downstream of the at least one fluid discharge channel allowing the respective channels to be sealed with the displaceable bolt is in the fifth, screen-changing position; or
k. the fluid is a thermoplastic melt.

7. The device of claim 3, characterized in that at least one of:
a. axial movement of the displaceable bolt from the first position into the third position results in the formation of the storage cavity for filtered fluid proximate the end face, wherein, over the entire distance of said axial movement, the outflow side of the filter unit is in communication with the at least one fluid discharge channel through the intermediary of the clean-fluid channel, the radial groove and the longitudinal groove;
b. the displaceable bolt is movable from the first position by radial rotation into a first intermediate position, wherein the fluid discharge channel is partially or completely sealed by the wall of the axially displaceable and radially rotatable bolt, wherein when completely sealed, the axially extending longitudinal groove of the displaceable bolt is no longer in communication with the at least one fluid discharge channel;
c. the displaceable bolt is moveable to a second intermediate position, wherein the fluid feed channel is partially or completely sealed by the wall of the axially displaceable and radially rotatable bolt, wherein when completely sealed, the inflow side of the filter unit of the displaceable bolt is no longer in communication with the at least one fluid feed channel;
d. the longitudinal groove extends only over some of the axial length of the axially displaceable and radially rotatable bolt;
e. each filter unit is associated with at least one back-flushing channel;
f. the displaceable bolt is provided with an outlet channel, wherein with the bolt in a fourth position, the outlet channel can be brought into fluid communication with the fluid feed channel and has an opening to the surrounding area of the device;
g. the housing comprises a plurality of parts, each of the plurality of parts having the bore, the fluid feed channel, the fluid discharge channel, the axially displaceable and radially rotatable bolt, the filter unit, the at least one back-flushing channel and the outlet channel;
h. the displaceable bolt is movable into a fifth, screen-changing position, wherein the filter unit is outside of the housing to allow replacement of the filter unit;
i. the displaceable bolt is movable into a fifth, screen-changing position, wherein the filter unit is outside of the housing to allow replacement of the filter unit and the at least one fluid feed channel and the at least one fluid discharge channel are completely sealed by the axially displaceable and radially rotatable bolt;
j. at least one shut-off valve is provided upstream of the at least one fluid feed channel and at least one shut-off valve is provided downstream of the at least one fluid discharge channel allowing the respective channels to be sealed with the displaceable bolt is in the fifth, screen-changing position; or
k. the fluid is a thermoplastic melt.

8. The device of claim 4, characterized in that at least one of:
a. axial movement of the displaceable bolt from the first position into the third position results in the formation of the storage cavity for filtered fluid proximate the end face, wherein, over the entire distance of said axial movement, the outflow side of the filter unit is in communication with the at least one fluid discharge channel through the intermediary of the clean-fluid channel, the radial groove and the longitudinal groove;
b. the displaceable bolt is movable from the first position by radial rotation into a first intermediate position, wherein the fluid discharge channel is partially or completely sealed by the wall of the axially displaceable and radially rotatable bolt, wherein when completely sealed, the axially extending longitudinal groove of the displaceable bolt is no longer in communication with the at least one fluid discharge channel;
c. the displaceable bolt is moveable to a second intermediate position, wherein the fluid feed channel is partially or completely sealed by the wall of the axially displaceable and radially rotatable bolt, wherein when completely sealed, the inflow side of the filter unit of the displaceable bolt is no longer in communication with the at least one fluid feed channel;
d. the longitudinal groove extends only over some of the axial length of the axially displaceable and radially rotatable bolt;
e. each filter unit is associated with at least one back-flushing channel;
f. the displaceable bolt is provided with an outlet channel, wherein with the bolt in a fourth position, the outlet channel can be brought into fluid communication with the fluid feed channel and has an opening to the surrounding area of the device;
g. the housing comprises a plurality of parts, each of the plurality of parts having the bore, the fluid feed channel, the fluid discharge channel, the axially displaceable and radially rotatable bolt, the filter unit, the at least one back-flushing channel and the outlet channel;
h. the displaceable bolt is movable into a fifth, screen-changing position, wherein the filter unit is outside of the housing to allow replacement of the filter unit;
i. the displaceable bolt is movable into a fifth, screen-changing position, wherein the filter unit is outside of the housing to allow replacement of the filter unit and the at least one fluid feed channel and the at least one fluid discharge channel are completely sealed by the axially displaceable and radially rotatable bolt;
j. at least one shut-off valve is provided upstream of the at least one fluid feed channel and at least one shut-off valve is provided downstream of the at least one fluid discharge channel allowing the respective channels to be sealed with the displaceable bolt is in the fifth, screen-changing position; or
k. the fluid is a thermoplastic melt.

9. The device of claim 5, comprising a plurality axially displaceable and radially rotatable bolts, wherein each displaceable bolt is movable independently between the first position, the second position, the third position, the fourth position, the fifth position and the first and second intermediate positions, wherein:
a. with the displaceable bolt in the first position, fluid is filtered; and
b. with the displaceable bolt in the second position, fluid does not flow through the filter unit of the axially displaceable and radially rotatable bolt, and the filter unit is subjected to a flow opposite a filtering direction of filtered fluid supplied from the storage cavity associated with the axially displaceable and radially rotatable bolt; and
wherein, during filtering by one of the plurality of axially displaceable and radially rotatable bolts, the storage cavity associated with the displaceable bolt is filled with filtered fluid through axial movement of a second displaceable bolt from the first position into the third position or into the third and simultaneously intermediate position, wherein at least some stored fluid is supplied to the filter unit of the one displaceable bolt through the movement of the second displaceable bolt when moved from the third position or the third position and simultaneously second intermediate position into the second position or the second position and simultaneously first intermediate position.

10. The device of claim 5, wherein the displaceable bolt is simultaneously in the second position and in the first intermediate position.

11. The device of claim 6, wherein the displaceable bolt is simultaneously in the second position and in the first intermediate position.

12. The device of claim 7, wherein the displaceable bolt is simultaneously in the second position and in the first intermediate position.

13. The device of claim 8, wherein the displaceable bolt is simultaneously in the second position and in the first intermediate position.

14. The device of claim 9, wherein the displaceable bolt is simultaneously in the second position and in the first intermediate position.

15. The device of claim 5, wherein the displaceable bolt is simultaneously in the third position and in the second intermediate position.

16. The device of claim 6, wherein the displaceable bolt is simultaneously in the third position and in the second intermediate position.

17. The device of claim 7, wherein the displaceable bolt is simultaneously in the third position and in the second intermediate position.

18. The device of claim 8, wherein the displaceable bolt is simultaneously in the third position and in the second intermediate position.

19. The device of claim 9, wherein the displaceable bolt is simultaneously in the third position and in the second intermediate position.
